(19) United States
(12) Patent Application Publication
(10) Pub. No.: US 2006/0141887 A1
(43) Pub. Date: Jun. 29, 2006

(54) Cross-direction elastic film laminates, and methods of making same

(76) Inventor: Michael Tod Morman, Knoxville, TN (US)

Correspondence Address: Melanie I. Rauch;Pauley Petersen & Erickson, Suite 365, 2800 West Higgins Road, Hoffman Estates, IL, 60195, US

(21) Appl. No.: 11/021,027

(22) Filed: Dec. 23, 2004

(51) Int. Cl. B32B 27/12

(52) U.S. Cl. 442/394

(57) ABSTRACT

A film laminate having cross-directional elasticity includes an elastomeric film laminated to at least one neckable facing layer such that fibers of the facing layer are attached to the elastomeric film. The laminate can be made by applying an elastic polymer, such as a liquid elastic polymer, onto a neckable nonwoven web to form a laminate; longitudinally slitting the laminate into a plurality of laminate strips; and necking the plurality of laminate strips. The method may be timed such that a setting of elastic memory in the elastic polymer occurs after the plurality of laminate strips are necked.

### BACKGROUND OF THE INVENTION

This invention is directed to film laminates having cross-directional elasticity, and methods of making such film laminates

Film laminates may be formed by stretching a film to provide breathability within the film, and then bonding the film to at least one facing material, such as a nonwoven web. The resulting laminate lacks any appreciable stretchability and/or elasticity.

A necking process, which is often used to impart cross-direction stretch to various materials, can be applied to film laminates. Necking processes generally involve tensioning a fabric in a particular direction thereby reducing the width dimension of the fabric in the direction perpendicular to the direction of tension. For example, tensioning a nonwoven fabric in the machine direction causes the fabric to “neck” or narrow in the cross direction and give the necked fabric cross direction extendability. Examples of such extensible fabrics include, but are not limited to, those described in U.S. Pat. No. 4,965,122 to Morman et al. and U.S. Pat. No. 5,336,545 to Morman et al. each of which is incorporated herein by reference in its entirety in a manner consistent with the invention.

Necking film laminates will produce a cross-directional extendible material, but the laminate will have little or no power retraction. If a set elastomeric material is attached to the film laminate before the laminate is necked, the necked material will pop back out to its prenecked dimensions after the necking tension has been removed because of the tendency of the elastomer to return toward its relaxed, original dimensions.

Additionally, necking a nonwoven web causes the nonwoven fibers to become closer together in the necking direction and more aligned in the stretching direction, without noticeably stretching or narrowing the individual fibers. The material narrows more in the cross direction (necking direction) than it is elongated in the machine direction (tensioning direction) so the necked nonwoven web generally has a higher basis weight than the starting nonwoven web. However, the web does not possess uniform basis weight and/or extendibility in the cross direction. More particularly, the nonwoven fibers along the longitudinal edges of the starting nonwoven web travel a greater distance in the cross direction between nip rolls or other tensioning devices during the necking process, compared to fibers in the central region. Furthermore, the cross-directional stresses in the central region are at least partially counteracted, because these stresses are applied in both cross directions, whereas the cross-directional stresses in each of the longitudinal edge regions are in just one direction, which is inward toward the central region of the nonwoven web. This results in increased fiber gathering and necking along the longitudinal edge regions. Consequently, the fibers in the longitudinal edge regions of the necked nonwoven web are generally more aligned and closer together than the fibers in the central region. As a result, the necked nonwoven web becomes non-uniform in the cross direction, having greater gathering and thus a higher basis weight and extendibility in both edge regions than in the central region. If this necked web is then slit into a desired number of strips, the strips including each edge portion of the necked nonwoven web will have different properties, edge to edge, than the center strips.

One further challenge that often exists in the manufacture of film laminates with only one facing is the prevention of roll blocking. Due to inherent tackiness in certain films, particularly in combination with certain facing materials, it is often necessary to utilize facings on both surfaces of the film in order to avoid roll blocking during processing and/or storage. For the purposes of this application, the term “roll blocking” refers to the propensity of tacky films or other tacky sheet materials to stick to themselves upon being rolled up for storage, prior to final use. Such roll blocking may prevent use of the material contained on a roll as a result of the inability to unwind such rolled material when it is actually needed.

There is thus a need or desire for a film laminate having cross-directional elasticity, and a method of making such laminates. There is a further need or desire for a method of making film laminates having cross-directional elasticity in which multiple substantially identical strips of the laminate can be formed, each strip having a substantially similar cross-directional profile in basis weight and extendibility. There is yet a further need or desire for a method of making film laminates having cross-direction elasticity and having just one facing layer, wherein the laminates are capable of being stored on a roll without concern for roll blocking.

### SUMMARY OF THE INVENTION

In response to the discussed difficulties and problems encountered in the prior art, new film laminates having cross-directional elasticity, and methods of making such film laminates, have been discovered.

The film laminates of the invention may include an elastomeric film laminated to at least one neckable facing layer such that fibers of the facing layer are attached to the elastomeric film. The laminate is necked and thus possesses cross-directional elasticity. The elastomeric film may include a thermoset polymer, such as a thermoset reactive elastomer, which may be activated using UV light, radiation, ultrasound, heat, chemicals, or a combination of any of these or other suitable activators. More particularly, the elastomeric film may include polyurethane, or a latex elastomer. The choice of elastic polymer can prevent roll blocking, even when a single facing layer is present in the laminate. In any case, the elastomeric film may be breathable.

In certain embodiments, the elastomeric film may include at least two layers, with one layer including an elastomeric base polymer and a second layer including an elastomeric base polymer in combination with a tackifier. The tackified layer may be positioned between the non-tackified layer and the facing layer, thereby securing the laminate together. The at least one neckable facing layer may include, for example, a nonwoven web.

The laminate may be formed by applying an elastic polymer onto a neckable nonwoven web to form the laminate, longitudinally slitting the laminate into a plurality of laminate strips, and longitudinally stretching the plurality of laminate strips to cause necking of the laminate strips. The elastic polymer may be molten when applied to the neckable nonwoven web, thereby allowing fibers of the nonwoven web to become locked into the resulting elastomeric film. Furthermore, the setting of elastic memory in the elastic polymer may be timed to occur after the laminate strips are necked. The elastic set or elastic memory may be generated by cooling or by molecular rearrangement after cooling, as often occurs in thermoplastic polyurethanes. For example, most of the elasticity within the elastic polymer may be generated at least 15 seconds, or at least 30 seconds, or at least 1 minute after applying the elastic polymer onto the neckable nonwoven web. Therefore, the laminate strips may be necked within about 30 seconds, or within about 20 seconds, or within about 10 seconds of applying the elastic polymer to the neckable nonwoven web. It may be desirable to keep the film warm in order to slow memory generation until after the slitting and necking have occurred. Additionally, pressure may be applied to the laminate to further lock the fibers of the nonwoven web into the elastic polymer, suitably before the elastic polymer has set.

When the elastic polymer includes a thermoset reactive elastomer or a pre-elastomer, the elastic polymer may be activated after necking the laminate strips, such that the laminate is necked as a unit and maintains a unified necked configuration.

The resulting film laminate includes a plurality of laminate strips, each laminate strip having a uniform cross-directional profile such that each strip has a substantially similar cross-directional profile in basis weight and extendibility. Furthermore, the elastic properties of the laminate are remarkable, since the film and nonwoven web are necked as a unit and will thus extend and retract as a unit. The film laminate is particularly suitable for use in absorbent articles and as a barrier material.

With the foregoing in mind, it is a feature and advantage of the invention to provide film laminates having cross-directional elasticity, and methods of making such laminates.

### BRIEF DESCRIPTION OF THE DRAWINGS

These and other objects and features of this invention will be better understood from the following detailed description taken in conjunction with the drawings, wherein:

FIG. 1 schematically illustrates a laminating and necking process in which a neckable laminate is formed, then slit or cut into a plurality of neckable laminate strips, and each material strip is necked, in accordance with certain embodiments of the invention.

FIG. 2 schematically illustrates exemplary slitting and necking steps of certain embodiments of the invention.

FIG. 3 is a schematic cross-sectional view of a film laminate, in accordance with certain embodiments of the invention.

FIG. 4 illustrates an absorbent article utilizing a film laminate, in accordance with certain embodiments of the invention.

### DEFINITIONS

Within the context of this specification, each term or phrase below will include the following meaning or meanings.

“Absorbent article” includes personal care products, medical garments, and the like. The term “personal care product” includes diapers, diaper pants, training pants, swimwear, absorbent underpants, adult incontinence products, feminine hygiene products, and the like.

“Bonded carded webs” refers to webs that are made from staple fibers which are usually purchased in bales. The bales are placed in a fiberizing unit/picker which separates the fibers. Next, the fibers are sent through a combining or carding unit which further breaks apart and aligns the staple fibers in the machine direction so as to form a machine direction-oriented fibrous nonwoven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calender rolls or ultrasonic bonding equipment is used to bond the fibers together, usually in a localized bond pattern through the web and/or alternatively the web may be bonded across its entire surface if so desired. When using bicomponent staple fibers, through-air bonding equipment is, for many applications, especially advantageous.

“Breathable” refers to a film, laminate, or other sheet material having a water vapor transmission rate (WVTR) of at least about 500 grams/m²-24 hours, using the WVTR Test Procedure described in U.S. Pat. No. 6,811,865 to Morman et al., which is hereby incorporated by reference in its entirety in a manner consistent with the invention. Breathable materials typically rely on molecular diffusion of vapor, or vapor passage through micropores, and are substantially liquid impermeable.

“Elastic” and “elastomeric” are used interchangeably to refer to a material or composite that is generally capable of recovering its shape after deformation when the deforming force is removed. Specifically, as used herein, elastic or elastomeric is meant to be that property of any material which, upon application of a biasing force, permits the material to be extendible to a stretched biased length which is at least about 50 percent greater than its relaxed unbiased length, and that will cause the material to recover at least 40 percent of its elongation upon release of the stretching force. A hypothetical example which would satisfy this definition of an elastomeric material would be a one (1) inch sample of a material which is elongatable to at least 1.50 inches and which, upon being elongated to 1.50 inches and released, will recover to a length of less than 1.30 inches. Many elastic materials may be stretched by much more than 50 percent of their relaxed length, and many of these will recover to substantially their original relaxed length upon release of the stretching force.

“Elastomer” refers to a polymer that is elastomeric.

“Pre-elastomer” or “pre-elastomeric” refers to a polymer that is not elastomeric in its current state, but has the potential to become elastomeric through the application of temperature, time, radiation, or other suitable activators. For example, a molten thermoplastic polyurethane elastomer may be a pre-elastomer until after cooling and setting for a period of time, which results in an elastomer.

“Extendible” mean elongatable in at least one direction, but not necessarily recoverable.

“Film” refers to an article of manufacture whose width exceeds its thickness and provides the requisite functional advantages and structure necessary to accomplish the claimed invention.

“Laminate” refers to a composite structure of two or more sheet material layers that have been adhered through a bonding step, such as through adhesive bonding, thermal bonding, point bonding, pressure bonding, extrusion coating, or ultrasonic bonding.

“Machine direction” or MD means the direction along the length of a fabric in the direction in which it is produced. The terms “cross machine direction,” “cross directional,” or CD mean the direction across the width of fabric, i.e. a direction generally perpendicular to the MD.

“Meltblown fibers” refers to fibers formed by extruding a molten thermoplastic material through a plurality of fine, usually circular, die capillaries as molten threads or filaments into converging high velocity gas streams (for example, airstreams) which attenuate the filaments of molten thermoplastic material to reduce their diameter, which may be to microfiber diameter. Such a process is disclosed, for example, by U.S. Pat. No. 3,849,241 to Butin, which is hereby incorporated by reference in its entirety in a manner consistent with the invention.

“Nonwoven” and “nonwoven web” refer to materials and webs of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunbonding processes, air laying processes, and bonded carded web processes.

“Polymer” and “polymeric,” when used without descriptive modifiers, generally include but are not limited to, homopolymers, copolymers, such as for example, block, graft, random and alternating copolymers, terpolymers, etc. and blends and modifications thereof. Furthermore, unless otherwise specifically limited, the term “polymer” includes all possible spatial configurations of the molecule. These configurations include, but are not limited to isotactic, syndiotactic and random symmetries.

“Sheet” and “sheet material” shall be interchangeable and, in the absence of a word modifier, shall refer to woven materials, nonwoven webs, polymeric films, polymeric scrim-like materials, and polymeric foam sheeting. The basis weight of nonwoven fabrics or films is usually expressed in ounces of material per square yard (osy) or grams per square meter (g/m² or gsm) and the fiber diameters are usually expressed in microns. (Note that to convert from osy to gsm, multiply osy by 33.91). Film thicknesses may also be expressed in microns or mil.

“Spunbond” refers to small diameter fibers which are formed by extruding molten thermoplastic material as filaments from a plurality of fine, usually circular capillaries of a spinneret with the diameter of the extruded filaments being rapidly reduced as by means shown, for example in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,542,615 to Dobo et al., each of which is incorporated by reference in its entirety herein.

“Thermoplastic” describes a material that softens when exposed to heat and which substantially returns to a nonsoftened condition when cooled to room temperature.

“Thermoset” describes a material that is capable of becoming chemically or structurally altered, such as becoming permanently cross-linked, and cannot be further thermally processed following such alteration.

“Thermoset reactive elastomer” describes a thermoset elastomer that can be set, or the setting of which can be accelerated, using an appropriate activator, such as UV light, radiation, ultrasound, heat, and/or chemicals, for example.

These terms may be defined with additional language in the remaining portions of the specification.

### DESCRIPTION OF PREFERRED EMBODIMENTS

In accordance with the invention, a film laminate is necked to impart cross-directional elasticity to the laminate. In general, an elastomeric or pre-elastomeric film is laminated to at least one neckable facing layer such that fibers of the facing layer are attached to or locked into the elastomeric film, and the laminate is slit and necked.

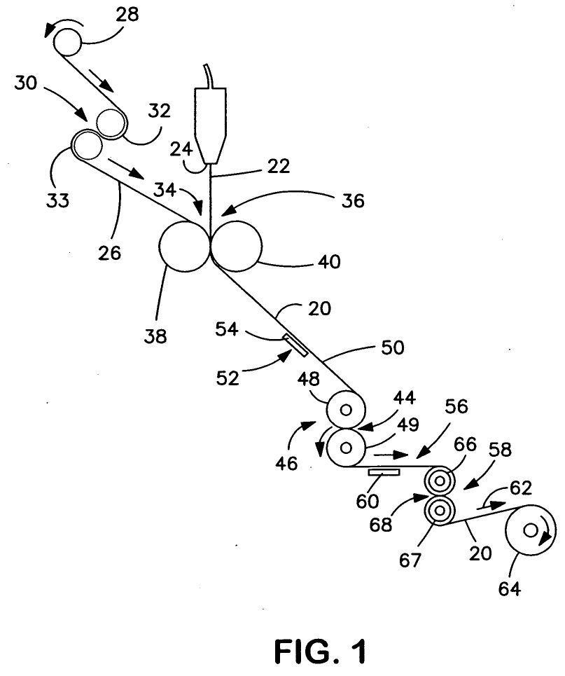

Referring to FIG. 1, there is shown an embodiment of a method of producing a film laminate 20. More specifically, as shown, an elastomeric film 22 is formed from an elastic or pre-elastic polymer. The film 22 may be formed, as shown in FIG. 1, by extruding the elastic polymer through a die 24. The elastic polymer is suitably a thermoset polymer, such as a thermoset reactive elastomer, which may be activated using UV light, radiation, ultrasound, heat, chemicals, or a combination of any of these or other suitable activators. In certain embodiments the elastic polymer may be a polyurethane, or a latex elastomer. Exemplary elastomeric materials that may be used to form the elastomeric film 22 include polyurethane elastomeric materials such as, for example, those available under the trademark ESTANE from B.F. Goodrich & Co. or MORTHANE from Morton Thiokol Corp.

In certain embodiments, the elastomeric film 22 may be a multilayer material in that it may include two or more individual coherent sheets of material. For example, one layer may include an elastomeric base polymer, such as thermoplastic polyurethane or any suitable thermoset polymer, and a second layer may include an elastomeric base polymer in combination with a tackifier. The elastomeric or pre-elastomeric polymers may be the same or different. Any tackifier resin that is compatible with the elastic polymer and that can withstand the high processing (e.g. extrusion) temperatures can be used. Generally, hydrogenated hydrocarbon resins are suitable tackifying resins because of their temperature stability. REGALREZ and ARKON P series tackifiers are examples of hydrogenated hydrocarbon resins. ZONATAK 501 lite is an example of a terpene hydrocarbon. REGALREZ hydrocarbon resins are available from Hercules Incorporated. ARKON P series resins are available from Arakawa Chemical (U.S.A.) Incorporated. The tackified layer may be positioned between the non-tackified layer and a facing layer 26, thereby securing the laminate 20 together. In certain embodiments, the elastomeric film 22 may be either a single layer or a multilayer material bonded to the facing layer 26 using a suitable tackifier that is applied to either the film 22 or the facing layer 26 without being combined within either layer.

The elastomeric film 22 may be formed using any of a number of conventionally known processes, including but not limited to flat die extrusion, blown film (tubular) processes, casting, and the like. For example, when forming the elastomeric film 22 from polyurethane using a flat film extrusion formation process, the polyurethane may be extruded into an elastomeric film at a temperature between about 150 and about 250 degrees Celsius.

At the same time, at least one neckable facing layer 26 is unwound from a supply roll 28, or formed directly within the same process without first being stored on a supply roll, and travels in the direction indicated by the arrow associated therewith as the supply roll 28 rotates in the direction of the arrow associated therewith. The facing layer 26 may pass through the nip of an S-roll arrangement 30 formed by stack rollers 32 and 33. The facing layer 26 is configured to advance to a contact zone 34 where the elastic polymer, in the form of the elastomeric or pre-elastomeric film 22, is applied to the facing layer 26. The laminate 20 includes at least one facing layer 26. In certain embodiments including two or more facing layers 26, at least one facing layer 26 may be attached to each surface of the elastomeric film 22.

The at least one facing layer 26 may include a nonwoven web. Alternatively, the facing layer may be knit or loosely woven fabric. The facing layer 26 may be formed by any of a number of processes known in the art, such as meltblowing processes, spunbonding processes, bonded carded web processes, and the like. Alternatively, the facing layer 26 may be a multilayer laminate, which may include spunbond and meltblown layers, such as in a spunbond/meltblown/spunbond laminate. The facing layer 26 suitably has a basis weight between about 0.1 and about 12 ounces per square yard (osy) (about 3.4 to about 400 grams per square meter (gsm)), or between about 0.75 and about 3 osy (about 25.4 to about 101.73 gsm).

The neckable facing layer 26 may be made from any material that can be treated while necked so that, after treatment, upon application of a force to extend the necked material to its prenecked dimensions, the material recovers generally to its necked dimensions upon termination of the force. A method of treatment is the application of heat. Thus, the neckable facing layer 26 may be made of such fiber forming polymers as, for example, nylons, polyesters, and/or polyolefins. Exemplary polyolefins include one or more of polyethylene, polypropylene, polybutene, ethylene copolymers, propylene copolymers and butene copolymers. Useful polypropylenes include, for example, polypropylene available from the Himont Corporation under the trade designation PF-374, polypropylene available from the Exxon-Mobil Chemical Company under the trade designation ESCORENE PD-3445, and polypropylene available from the Shell Chemical Company under the trade designation DX 5A09. Polyethylenes may also be used, including ASPUN 6811A and 2553 linear low density polyethylenes from the Dow Chemical Company, as well as various high density polyethylenes. Chemical characteristics of these materials are available from their respective manufacturers.

The facing layer 26 may also be a composite material made of a mixture of two or more different fibers or a mixture of fibers and particulates. Such mixtures may be formed by adding fibers and/or particulates to the gas stream in which meltblown fibers are carried so that an intimate entangled commingling of meltblown fibers and other materials, e.g. wood pulp, staple fibers, and particulates such as, for example, superabsorbent materials, occurs prior to collection of the fibers upon a collecting device to form a coherent web of randomly dispersed meltblown fibers and other materials.

When the elastic polymer is applied to the facing layer 26 in a molten or other liquid state, fibers of the facing layer 26 may be locked into the elastomeric film 22 once the film cools and/or sets. This feature is particularly evident when using an elastic polymer that does not establish its elasticity from the melt for a period of time, such as polyurethane. After the molten material is formed, very little elastic property generation occurs for the first one-quarter of a minute or so and good elasticity does not occur for about 15 minutes, although the exact timing is dependent on the particular polyurethane polymer used.

By applying the liquid elastic polymer to the facing layer 26 and subsequently necking the laminate 20 as a unit, and then drying or otherwise reacting the polymer, the fibers of the facing layer 26 may be physically locked into the film 22 when the laminate 20 is in the necked configuration, which creates an elastic laminate 20 that has the tendency to retract to the necked configuration after force is applied (and subsequently released) in the cross direction. In contrast, if the facing layer 26 is necked prior to applying the liquid elastic polymer, thereby aligning the fibers in the machine direction, and the fibers lock into the elastic polymer when just the facing layer 26 is necked, the facing layer fibers almost have to cut through the elastic film 22 when the laminate 20 is stretched in the cross direction, thus creating resistance to the stretching. Therefore, it is beneficial to apply the liquid elastic polymer to the facing layer 26 and subsequently neck the entire laminate 20 as a unit. Furthermore, in comparison to thermoset polymers, the elastic properties of thermoplastic elastomers are less durable. That is, thermoplastic elastomers are more easily permanently deformed. Thus, thermoset polymers may be more suitable for the film laminates 20 formed by the methods described herein.

Molten polyurethane, or other molten elastic polymers, can be forced into the facing layer 26. Even if the elastic polymer does not stick to the facing layer 26, the elastic polymer can be pushed into the facing layer 26 to lock the fibers into the elastic polymer. For example, at the contact zone 34, the elastomeric film 22 and the facing layer 26 may be introduced into the nip of a pressure roll arrangement 36. The pressure roll arrangement 36 may include at least a first pressure roll 38 and a second pressure roll 40 which can be set to define a controlled gap between the rolls. Alternatively, the pressure rolls 38 and 40 may be set to define a pressurized nip such that the rolls 38 and 40 are essentially in contact when no sheet is between the rolls (i.e., in the absence of material). The laminate material 20 that exits the nip is a unitary structure.

Alternatively, other bonding methods can be used to adhere the elastomeric film 22 to the facing layer 26, such as, but not limited to, adhesive, thermal, hydroentangling, ultrasonic, and other methods of laminating known to those skilled in the art.

Suitably, before the elastic polymer has set or the pre-elastomeric polymer reacted, the laminate 20 can be moved directly to a necking assembly 42. More particularly, the laminate 20 can be transported to and fed through a first transporting device, for example a nip 44 formed between a first pair of nip rollers 46 including roller 48 and roller 49. The laminate 20 may have an initial prenecked or starting width of about 30 inches (76.2 cm) to about 720 inches (18.3 m), or about 100 inches (254 cm) to about 540 inches (13.7 m). The first pair of nip rollers 46 pulls the laminate 20 through the rollers 48, 49 in the machine direction.

In certain embodiments, the rollers 48 and 49 may be heated to a constant temperature across a lateral direction of each roller 48, 49, or selectively heated according to a profile that yields higher temperatures in a first portion of the roller surface and a relatively lower temperature in a second portion of the roller surface.

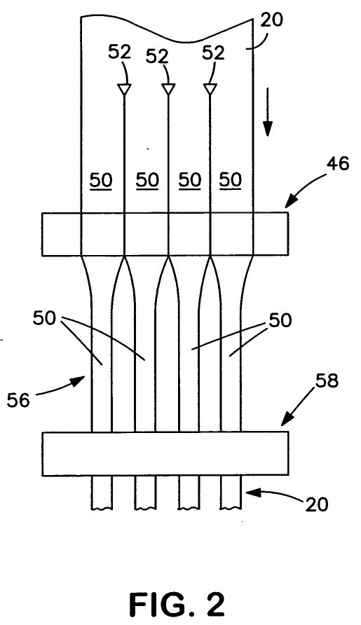

As shown in FIGS. 1 and 2, prior to passing through the first nip 44, the laminate 20 is slit or cut longitudinally into a plurality of neckable laminate strips 50 using a suitable cutting device 52, for example a plurality of cutting knives 54. Any suitable slitting or cutting device known to those having ordinary skill in the art may be used to form neckable laminate strips 50. Desirably, but not necessarily, the neckable laminate strips 50 have a uniform width. Suitably, the laminate 20 is cut into at least two neckable laminate strips 50, or at least six neckable laminate strips 50, and in some cases at least twenty neckable laminate strips 50. Prior to necking, the neckable laminate strips 50 may each have a width of about 9 inches (23 cm) to about 90 inches (229 cm), or about 15 inches (38 cm) to about 72 inches (183 cm), or about 20 inches (51 cm) to about 54 inches (137 cm).

For example, the laminate 20 having an initial or starting width of about 360 inches (914 cm) may be cut into ten neckable laminate strips 50 with each neckable laminate strip 50 having a width of about 36 inches (91 cm). Alternatively, the laminate 20 may be cut into thirty neckable laminate strips 50 each having a width of about 12 inches (30 cm). It should be apparent to those having ordinary skill in the art that the laminate 20 may be cut to form any suitable number of neckable laminate strips 50, depending upon the starting width of the laminate, the degree of necking, and the desired width of the final product.

After passing between the first pair of nip rollers 46, the laminate 20 in the form of the plurality of neckable laminate strips 50 enters a necking zone 56, defined as a longitudinal (necking) distance in the machine direction between the first pair of nip rollers 46 and a second pair of nip rollers 58, as shown in FIG. 2. Generally, the minimum required distance between nips for good necking is approximately proportional to the width of the laminate being necked. That is, all other material and process conditions being held constant, doubling the width of a laminate approximately doubles the minimum required distance between nips for good necking. Conversely, if a laminate having a minimum required distance between nips for good necking of “X” for a given set of processing conditions is slit into “N” individual strips, the minimum required distance for good necking at those same processing conditions is reduced from “X” to approximately “X/N.” For example, if “N” equals 10 strips, the minimum required distance between nips for good necking is reduced 90 percent. Suitably, the necking distance is less than about 40 times the slit width, or about 20 times the slit width, or about 10 times the slit width, and in certain cases about 4 times the slit width. Generally, shorter necking distances are desirable to ensure good web control of the slit. To achieve good necking, often a necking distance between nips of 4 to 10 times the laminate width is suitable. The necking distance should be great enough to give the fibers making up the facing layer enough time to orient and move to enable the material necking process to occur. If the laminate is slit into “y” strips before necking, this distance becomes (4/y) to (10/y) times the width of the original laminate. This relatively short necking distance, made possible by slitting the neckable laminate material into a plurality of neckable strips, saves factory floor space and produces necked laminate strips having a substantially similar basis weight and cross-directional extendibility profiles.

Further, the minimum required distance between nips for good necking is generally related to the line speed. That is, if the line speed is doubled, the minimum required distance for good necking increases. The distance divided by the line speed between nips is the time the laminate is in the necking zone between nips. Decreasing this time by increasing line speed may not give the filaments in the material enough time to reorient. This reorientation is what causes the necking to occur. As discussed above, the minimum distance between nips for good necking can be decreased by slitting a laminate into strips. This reduction in minimum distance can be used on an existing machine to increase line speeds and still attain acceptable necking.

It has been found that, in general, for a given laminate necked to a given amount, the ratio of laminate width times line speed divided by distance between draw nips must be less than a given value determined experimentally. If the effective laminate width can be reduced by slitting the laminate before necking, the line speed can be proportionally increased and/or the nip distance decreased. For example, if the laminate is slit into twelve (12) equal slits, in general the line speed can be increased about three times and the necking distance decreased to about ¼ of an initial or original necking distance.

In accordance with certain embodiments of this invention, each neckable laminate strip 50 is necked from an initial or starting width to a necked width which is less than its initial width within the necking zone 56. Suitably, the necked or final width of each laminate strip 50 is less than about 80% of the initial width of the laminate strip 50, or less than about 65% of the initial width of the laminate strip 50, or about 28% to about 50% of the initial width of the neckable laminate strip 50. Each laminate strip 50 may have a necked width of at least about 2 inches, and is often wider depending on the dimensional requirements of the end use product. In certain embodiments of this invention, the necked width of each neckable laminate strip 50 may be substantially wider depending on the initial prenecked width of the neckable laminate strips 50 and the amount of necking. Additionally, each necked laminate strip 50 may have a necked machine direction length that is about 1.05 times to about 1.7 times, or about 1.1 times to about 1.5 times, or about 1.2 times to about 1.4 times its initial starting length caused by the drawing process. After the necking process is completed, the necked laminate strips 50 may be processed or converted inline or may be wound onto a storage or winding roll 64 for future processing and/or converting.

In one embodiment of this invention, a heating device 60 shown schematically in FIG. 1, for example a heating oven or any other suitable heating device known to those having ordinary skill in the art, may be provided in the necking zone 56. Suitably, the heating device 60 heats each laminate strip 50 to an elevated temperature of about 180 degrees Fahrenheit (82.2 degrees Celsius) to about 280 degrees Fahrenheit (138 degrees Celsius).

The heating device 60 can be a conventional open-ended forced air oven, through which the laminate 20 may pass as it travels between the first pair of nip rollers 46 and the second pair of nip rollers 58. The open-ended forced air oven may be used to aid in necking each neckable laminate strip 50 and heat setting each neckable laminate strip 50, at location 62 as shown in FIG. 1, resulting in a reversibly necked material. The temperature inside the oven should be high enough to soften the nonwoven fibers, and to increase their pliability, but not so high as to either melt the fibers or soften the fibers to such an extent that the necking process causes significant stretching, narrowing, and/or breaking of individual nonwoven fibers. When the nonwoven fibers are made from a polyolefin, for example, the highest temperature reached by the nonwoven web inside the oven should be at least about 20 degrees Celsius below the melting temperature of the fibers, or at least about 25 degrees below the melting temperature of the fibers, or at least about 30 degrees Celsius below the melting temperature of the fibers. Optimal necking temperatures may be about 20 degrees Celsius to about 85 degrees Celsius below the melting temperature of the fibers.

Alternatively, the heating device 60 may be a hot air knife as described, for example, in U.S. Pat. No. 5,707,468 to Arnold et al. the disclosure of which is hereby incorporated by reference in its entirety in a manner consistent with the invention. In a hot air knife assembly, one or more high velocity jets of hot air is applied to the surface of the laminate 20 through a device that includes an upper plenum and a lower slot or slots facing the moving neckable material 20.

The temperature of the heating device 60 should also be conducive to the desired setting of the elastic polymer in the necked configuration. “Setting” in the necked configuration may occur by erasing the pre-necked elastic memory in a thermoplastic elastomer and allowing it to cool in the necked configuration to give it a necked configuration memory, or causing a thermoset elastic polymer to react in the necked configuration, or drying a latex elastomeric polymer in the necked configuration. For a polymer such as thermoplastic polyurethane, which establishes its memory very slowly, the heating may further slow down the memory generation process.

In accordance with certain embodiments of the invention, the laminate 20 is slit and necked prior to setting the elastic memory in the elastic polymer. The setting or elastic memory generating process may occur rapidly after the elastic polymer is applied to the facing layer 26, depending upon the properties of the elastic polymer. However, if the laminate 20 is slit and necked within about 30 seconds, or within about 20 seconds, or within about 10 seconds of forming the laminate 20, that is, applying the elastic polymer to the neckable facing layer 26, sufficient setting occurs subsequent to slitting and necking to set the material in the necked configuration. Thus, the elastic memory of the film 22 can be generated when the laminate 20 is in a necked configuration. It may be desirable to keep the film 22 warm to slow memory generation until after the slitting and necking have occurred. For example, the heating device 60, or another heating device, may be used to maintain the laminate 20 at an elevated temperature, such as heating the laminate at a temperature of at least 100 degrees Celsius, or at least 120 degrees Celsius, or at least 140 degrees Celsius, until after the necking has been carried out. Additionally or alternatively, when the elastic polymer includes a thermoset reactive polymer, the elastic polymer may be activated either prior to necking, or, to further delay setting of the film, the elastic polymer may be activated after the necking has occurred. In certain embodiments, the elastic polymer may generate most of its elasticity after at least 15 seconds, or at least 30 seconds, or at least 1 minute, from applying the elastic polymer onto the facing layer 26. If the thermoset polymer reaction is initiated prior to the start of the necking process, the reaction should be closely controlled to ensure that most of the reaction occurs after necking the laminate.

After passing through the necking zone 56, the laminate 20 is pulled by a second transporting device. For example, the second transporting device may include a winding roll, such as a storage or winding roll 64, as shown in FIG. 1. The winding roll suitably has a constant rotational surface velocity greater than the first surface velocity of rollers 48 and 49, thereby maintaining the necking of each laminate strip 50 prior to winding the necked laminate strips 50 onto the winding roll. The winding speed may be greater than the surface velocity of rolls 66 and 67 to cause additional necking.

Alternatively, the second transporting device may include a second pair of nip rollers 58 including counter-rotating roller 66 and roller 67. The laminate 20 may pass directly through a second nip 68 formed by the counter-rotating second pair of nip rollers 58 or the laminate 20 may travel a path having a general S-configuration wherein the laminate 20 passes partially around and underneath the roller 66, then between the roller 66 and the roller 67, then partially around and over the roller 67. In one embodiment, the rollers 66 and 67 may be heated in a similar manner as discussed above with respect to rollers 48 and 49.

Each roller 66 and 67 has a constant second rotational surface velocity greater than the first surface velocity of rollers 48 and 49. The second surface velocity may be about 1.05 to about 1.7 times greater than the first surface velocity, or about 1.1 times to about 1.5 times the first surface velocity, or about 1.2 times to about 1.4 times the first surface velocity, for example. The surface velocity difference between the first pair of nip rollers 46 and the second pair of nip rollers 58, and in certain embodiments the heat applied to the laminate 20 in the necking zone 56, results in formation of a narrower or necked laminate 20 having a necked width (narrower slits) that is less than the initial or starting width of the laminate 20.

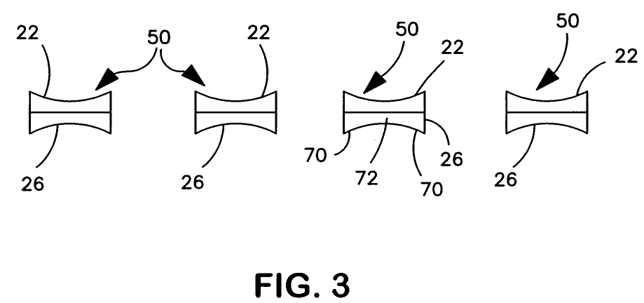

Referring to FIG. 3, a process in accordance with at least one embodiment of the invention provides a laminate 20 forming a plurality of necked laminate strips 50 each having cross directional elasticity, wherein adjacent strips 50 suitably have a similar, and desirably substantially identical slight “smile” profile in basis weight and extendibility in the cross direction. As shown in FIG. 3, each strip 50 includes laterally opposing edge portions or regions 70 having a higher basis weight and higher extendibility than a basis weight and extendibility of the central portion or region 72.

Processes that entail slitting and necking of a preformed elastic film laminate wherein the elastic is set or has an elastic memory can be performed relatively easily, but the necked material tends to pop back out to its prenecked dimensions after the necking tension has been removed because of the tendency of the set elastomer to return to its set configuration. By preventing the elastic memory from being set in the film, or erasing the pre-necked memory and establishing a memory or set at the necked width, until after the slitting and necking have occurred, an elastic film laminate can be produced in which the laminate has cross directional elasticity, including both extendibility and retraction.

Additionally, by forming the laminate in this manner, the resulting laminate may be breathable. One explanation for this effect may be that a small percentage of the fibers of the facing layer may be pulled out of the film, without separating the facing layer from the film, but instead creating a microporous film that is breathable. The film itself may also be inherently breathable.

Another benefit derived from the methods described herein is the reduction or elimination of roll blocking. In a variety of the embodiments described herein, the facing layer and the film layer inherently do not stick to one another, such as the combination of polyurethane films and polypropylene spunbond layers. These layers can be adhered to one another to form the laminate, for example, by applying the elastic polymer in a molten state and applying pressure, incorporating a tackifier in an intermediate elastic polymer layer, applying an adhesive between layers, or using a combination of any of these or other suitable techniques. Consequently, in embodiments having only a single facing layer, the exterior surface of the facing layer tends to not stick to the exterior surface of the elastomeric film when the laminate is wound on a roll. This feature is particularly advantageous when the laminate is used in such applications as car covers and other applications that benefit from water repellency, stretch/recovery, and breathability, such as garments, including coats, pants, and the like.

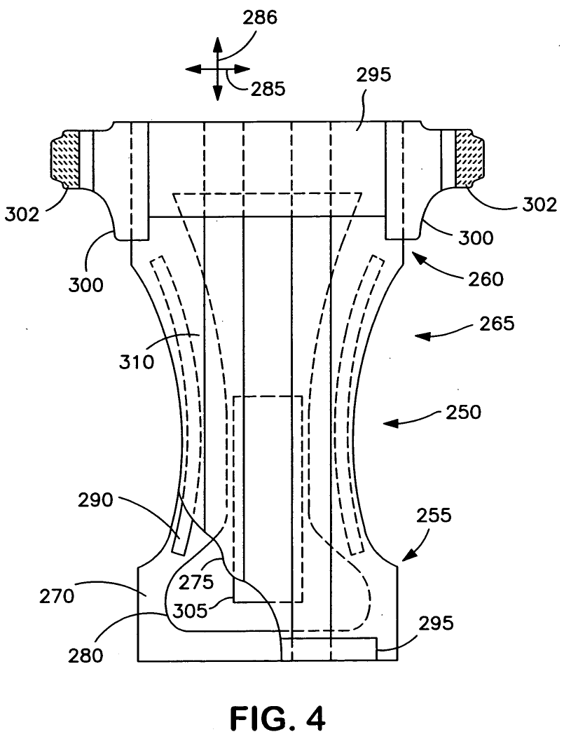

The film laminates 20 may be useful in providing extendible outer cover applications, as well as elastic waist, leg cuff/gasketing, stretchable ears, or side panels. While not intending to be limiting, FIG. 4 is presented to illustrate the various components of an absorbent article, such as a diaper, that may take advantage of such elastic materials. Other examples of absorbent articles that may incorporate such materials are training pants (such as in side panel materials) and feminine care products. By way of illustration only, training pants suitable for use with the invention and various materials and methods for constructing the training pants are disclosed in PCT Patent Application WO 00/37009 published Jun. 29, 2000 by A. Fletcher et al; U.S. Pat. No. 4,940,464 issued Jul. 10, 1990 to Van Gompel et al.; U.S. Pat. No. 5,766,389 issued Jun. 16, 1998 to Brandon et al.; and U.S. Pat. No. 6,645,190 issued Nov. 11, 2003 to Olson et al., which are each incorporated herein by reference in their entirety in a manner consistent with the invention.

With reference to FIG. 4, the disposable diaper 250 generally defines a front waist section 255, a rear waist section 260, and an intermediate section 265 which interconnects the front and rear waist sections. The front and rear waist sections 255 and 260 include the general portions of the diaper which are constructed to extend substantially over the wearer's front and rear abdominal regions, respectively, during use. The intermediate section 265 of the diaper includes the general portion of the diaper that is constructed to extend through the wearer's crotch region between the legs. Thus, the intermediate section 265 is an area where repeated liquid surges typically occur in the diaper.

The diaper 250 includes, without limitation, an outer cover, or backsheet 270, a liquid permeable bodyside liner, or topsheet, 275 positioned in facing relation with the backsheet 270, and an absorbent core body, or liquid retention structure, 280, such as an absorbent pad, which is located between the backsheet 270 and the topsheet 275. The backsheet 270 defines a length, or longitudinal direction 286, and a width, or lateral direction 285 which, in the illustrated embodiment, coincide with the length and width of the diaper 250. The liquid retention structure 280 generally has a length and width that are less than the length and width of the backsheet 270, respectively. Thus, marginal portions of the diaper 250, such as marginal sections of the backsheet 270 may extend past the terminal edges of the liquid retention structure 280. In the illustrated embodiments, for example, the backsheet 270 extends outwardly beyond the terminal marginal edges of the liquid retention structure 280 to form side margins and end margins of the diaper 250. The film laminates 20 of the inventive structure and methods are suitable for use as the backsheet 270. The topsheet 275 is generally coextensive with the backsheet 270 but may optionally cover an area which is larger or smaller than the area of the backsheet 270, as desired.

To provide improved fit and to help reduce leakage of body exudates from the diaper 250, the diaper side margins and end margins may be elasticized with suitable elastic members, as further explained below. For example, as representatively illustrated in FIG. 4, the diaper 250 may include leg elastics 290 which are constructed to operably tension the side margins of the diaper 250 to provide elasticized leg bands which can closely fit around the legs of the wearer to reduce leakage and provide improved comfort and appearance. Waist elastics 295 are employed to elasticize the end margins of the diaper 250 to provide elasticized waistbands. The waist elastics 295 are configured to provide a resilient, comfortably close fit around the waist of the wearer.

The film laminates 20 of the inventive structure and methods are suitable for use as the leg elastics 290 and waist elastics 295. Exemplary of such materials are laminate sheets which either comprise or are adhered to the backsheet, such that elastic constrictive forces are imparted to the backsheet 270. In certain embodiments, the laminate may be perforated and used as a liner or other liquid-permeable application.

As is known, fastening means, such as hook and loop fasteners, may be employed to secure the diaper 250 on a wearer. Alternatively, other fastening means, such as buttons, pins, snaps, adhesive tape fasteners, cohesives, fabric-and-loop fasteners, or the like, may be employed. In the illustrated embodiment, the diaper 250 includes a pair of side panels 300 (or ears) to which the fasteners 302, indicated as the hook portion of a hook and loop fastener, are attached. Generally, the side panels 300 are attached to the side edges of the diaper in one of the waist sections 255, 260 and extend laterally outward therefrom. The side panels 300 may be elasticized or otherwise rendered elastomeric by use of a film laminate made from the inventive structure. Examples of absorbent articles that include elasticized side panels and selectively configured fastener tabs are described in PCT Patent Application No. WO 95/16425 to Roessler; U.S. Pat. No. 5,399,219 to Roessler et al.; U.S. Pat. No. 5,540,796 to Fries; and U.S. Pat. No. 5,595,618 to Fries each of which is hereby incorporated by reference in its entirety in a manner consistent with the invention.

The diaper 250 may also include a surge management layer 305, located between the topsheet 275 and the liquid retention structure 280, to rapidly accept fluid exudates and distribute the fluid exudates to the liquid retention structure 280 within the diaper 250. The diaper 250 may further include a ventilation layer (not illustrated), also called a spacer, or spacer layer, located between the liquid retention structure 280 and the backsheet 270 to insulate the backsheet 270 from the liquid retention structure 280 to reduce the dampness of the garment at the exterior surface of a breathable outer cover, or backsheet, 270. Examples of suitable surge management layers 305 are described in U.S. Pat. No. 5,486,166 to Bishop and U.S. Pat. No. 5,490,846 to Ellis, each of which is hereby incorporated by reference in its entirety in a manner consistent with the invention.

As representatively illustrated in FIG. 4, the disposable diaper 250 may also include a pair of containment flaps 310 which are configured to provide a barrier to the lateral flow of body exudates. The containment flaps 310 may be located along the laterally opposed side edges of the diaper adjacent the side edges of the liquid retention structure 280. Each containment flap 310 typically defines an unattached edge which is configured to maintain an upright, perpendicular configuration in at least the intermediate section 265 of the diaper 250 to form a seal against the wearer's body. The containment flaps 310 may extend longitudinally along the entire length of the liquid retention structure 280 or may only extend partially along the length of the liquid retention structure. When the containment flaps 310 are shorter in length than the liquid retention structure 280, the containment flaps 310 can be selectively positioned anywhere along the side edges of the diaper 250 in the intermediate section 265. Such containment flaps 310 are generally well known to those skilled in the art. For example, suitable constructions and arrangements for containment flaps 310 are described in U.S. Pat. No. 4,704,116 to K. Enloe, which is hereby incorporated by reference in its entirety in a manner consistent with the invention.

The diaper 250 may be of various suitable shapes. For example, the diaper may have an overall rectangular shape, T-shape or an approximately hour-glass shape. In the shown embodiment, the diaper 250 has a generally I-shape. Other suitable components which may be incorporated on absorbent articles of the present invention may include waist flaps and the like which are generally known to those skilled in the art. Examples of diaper configurations suitable for use in connection with the instant invention which may include other components suitable for use on diapers are described in U.S. Pat. No. 4,798,603 to Meyer et al.; U.S. Pat. No. 5,176,668 to Bernardin; U.S. Pat. No. 5,176,672 to Bruemmer et al.; U.S. Pat. No. 5,192,606 to Proxmire et al. and U.S. Pat. No. 5,509,915 to Hanson et al. each of which is hereby incorporated by reference in its entirety in a manner consistent with the invention.

The various components of the diaper 250 are assembled together employing various types of suitable attachment means, such as adhesive bonding, ultrasonic bonding, thermal point bonding or combinations thereof. In the shown embodiment, for example, the topsheet 275 and backsheet 270 may be assembled to each other and to the liquid retention structure 280 with lines of adhesive, such as a hot melt, pressure-sensitive adhesive. Similarly, other diaper components, such as the elastic members 290 and 295, fastening members 302, and surge layer 305 may be assembled into the article by employing the above-identified attachment mechanisms.

It should be appreciated that such film laminate materials may likewise be used in other personal care products, protective outerwear, protective coverings and the like. Further such materials can be used in bandage materials for both human and animal bandaging products.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A film laminate comprising:
an elastomeric film laminated to at least one neckable facing layer such that fibers of the facing layer are attached to the elastomeric film, wherein the laminate is necked and possesses cross-directional elasticity.

2. The laminate of claim 1, wherein the elastomeric film comprises a thermoset polymer.

3. The laminate of claim 1, wherein the elastomeric film comprises a thermoset reactive elastomer.

4. The laminate of claim 1, wherein the elastomeric film comprises polyurethane.

5. The laminate of claim 1, wherein the elastomeric film comprises a latex elastomer.

6. The laminate of claim 1, wherein the elastomeric film is breathable.

7. The laminate of claim 1, wherein the elastomeric film comprises a first layer of an elastomeric base polymer and a second layer of an elastomeric base polymer in combination with a tackifier, wherein the second layer is positioned between the first layer and the facing layer.

8. The laminate of claim 1, wherein the at least one neckable facing layers comprises a nonwoven web.

9. The laminate of claim 1, comprising a plurality of laminate strips, wherein each of the laminate strips has a substantially identical cross-directional basis weight and/or extendability profile.

10. The laminate of claim 9, wherein opposing edge regions of each strip have a higher basis weight than a basis weight of a central region of each strip.

11. The laminate of claim 9, wherein opposing edge regions of each strip have a higher extendibility than an extendibility of a central region of each strip.

12. An absorbent article comprising the film laminate of claim 1.

13. A method of making a film laminate having cross-directional elasticity, comprising:
applying a liquid elastic polymer onto a neckable nonwoven web to form a laminate;
longitudinally slitting the laminate into a plurality of laminate strips; and
longitudinally stretching the plurality of laminate strips to cause necking of the laminate strips.

14. The method of claim 13, comprising applying heat to the laminate while slitting the laminate.

15. The method of claim 13, comprising applying heat to the laminate while stretching the plurality of laminate strips.

16. The method of claim 13, wherein the elastic polymer comprises a thermoset polymer.

17. The method of claim 13, wherein the elastic polymer comprises a thermoset reactive elastomer.

18. The method of claim 17, comprising activating the elastic polymer using at least one of the group consisting of UV light, radiation, ultrasound, heat, and chemicals.

19. The method of claim 17, comprising reacting the elastic polymer after necking the laminate strips.

20. The method of claim 13, wherein the elastic polymer comprises thermoplastic polyurethane.

21. The method of claim 13, wherein the elastic polymer comprises thermoset polyurethane.

22. The method of claim 13, wherein the elastic polymer comprises a latex elastomer.

23. The method of claim 13, wherein the elastic polymer comprises an elastomeric base polymer in combination with a tackifier, and comprising applying a layer of an elastomeric base polymer on top of the tackified elastomeric base polymer.

24. The method of claim 13, comprising applying pressure to the laminate to attach fibers of the nonwoven web to the elastic polymer.

25. A method of making a film laminate having cross-directional elasticity, comprising:
applying a pre-elastic polymer onto a neckable nonwoven web to form a laminate;
longitudinally slitting the laminate into a plurality of laminate strips;
longitudinally stretching the plurality of laminate strips to cause necking of the laminate strips; and
timing a setting of elastic memory in the pre-elastic polymer to occur after the plurality of laminate strips are necked.

26. The method of claim 25, comprising necking the laminate strips within about 30 seconds of applying the pre-elastic polymer to the neckable nonwoven web.

27. The method of claim 25, comprising necking the laminate strips within about 20 seconds of applying the pre-elastic polymer to the neckable nonwoven web.

28. The method of claim 25, comprising necking the laminate strips within about 10 seconds of applying the pre-elastic polymer to the neckable nonwoven web.

29. The method of claim 25, wherein the pre-elastic polymer comprises a thermoset polymer.

30. The method of claim 25, wherein the pre-elastic polymer comprises a thermoset reactive elastomer.

31. The method of claim 30, comprising activating the pre-elastic polymer using at least one of the group consisting of UV light, radiation, ultrasound, heat, and chemicals.

32. The method of claim 30, comprising activating the pre-elastic polymer after necking the laminate strips.

33. The method of claim 25, wherein the pre-elastic polymer comprises polyurethane.

34. The method of claim 25, wherein the pre-elastic polymer comprises a latex elastomer.

35. The method of claim 25, wherein the pre-elastic polymer comprises an elastomeric base polymer in combination with a tackifier, and comprising applying a layer of an elastomeric base polymer on top of the tackified elastomeric base polymer.

36. The method of claim 25, comprising applying pressure to the laminate to lock fibers of the nonwoven web into the pre-elastic polymer.

37. A wound roll of multiple strips of a necked-bonded laminate, each of the strips having substantially identical cross-directional basis weight and/or extendability properties.
